(19) United States
(12) Patent Application Publication
(10) Pub. No.: US 2008/0079367 A1
(43) Pub. Date: Apr. 3, 2008

(54) Light emitting device and control method thereof

(75) Inventor: Wen-Jyh Sah, Taishan Township (TW)

Correspondence Address: BIRCH STEWART KOLASCH & BIRCH, PO BOX 747, FALLS CHURCH, VA, 22040-0747, US

(73) Assignee: Gigno Technology Co., Ltd.

(21) Appl. No.: 11/905,457

(22) Filed: Oct. 1, 2007

(30) Foreign Application Priority Data
Oct. 2, 2006 (TW) 095136575
Jun. 5, 2007 (TW) 096120199
Sep. 21, 2007 (TW) 096135248

(51) Int. Cl. H05B 41/36

(52) U.S. Cl. 315/151

(57) ABSTRACT

A light emitting device includes at least one light emitting unit, a first switching unit, an energy storage unit and an optical sensing-control unit. The first switching unit is electrically connected to the light emitting unit. The energy storage unit is electrically connected to the first switching unit and stores electrical energy. The optical sensing-control unit electrically connected to the energy storage unit senses a light emitting energy of the light emitting unit and adjusts the electrical energy according to the light emitting energy. The first switching unit turns on and off according to the electrical energy so as to control the light emitting unit.

### CROSS REFERENCE TO RELATED APPLICATIONS

This Non-provisional application claims priority under 35 U.S.C. §119(a) on Patent Application No(s). 095136575, 096120199 and 096135248 filed in Taiwan, Republic of China on Oct. 2, 2006, Jun. 5, 2007, and Sep. 21, 2007, the entire contents of which are hereby incorporated by references.

### BACKGROUND OF THE INVENTION

1. Field of Invention

The invention relates to a light emitting device and a control method thereof, and, in particular, to a light emitting device possessing a self-feedback function and a control method thereof.

2. Related Art

In a LCD (Liquid Crystal Display) apparatus, a cathode fluorescent lamp typically serves as a light emitting unit of a backlight module. However, the color properties of light emitted by a cathode fluorescent lamp are inferior to that of the LED (Light Emitting Diode). So, some manufacturers have used the LEDs as the light emitting devices of the backlight module of the LCD apparatus in the early stages of this developing field of LED technology.

LCD apparatuses, such as LCD televisions, need several tens to several hundreds of LEDs to construct the backlight module. In an effort to better represent true colors and more accurately display frames, controlling the average luminance of the LEDs has become an important engineering task.

As shown in FIG. 1A, a conventional backlight module has a plurality of LEDs 11, a photosensor 12 and a controller 13. The photosensor 12 receives light generated by each LED 11 and thus generates a feedback signal that is transferred to the controller 13. The controller 13 adjusts the luminance of the corresponding LEDs 11 according to the feedback signal.

Recently, another backlight module, in which the LEDs 11 are divided into several zones, was disclosed. As shown in FIG. 1B, for example, the LEDs 11 are divided into 12 zones, each of which is composed of four LEDs 11 and one photosensor 12, so that the luminance of the LEDs may be adjusted in a zoning manner. However, because the LEDs 11 are divided into 12 zones, the controller (not shown) for adjusting the luminance of the LEDs 11 needs 12 channels to control the LEDs 11 of the 12 zones, respectively. When the number of the LEDs of the backlight module is increased or the LEDs are divided into more zones, the number of the channels of the controller also increases correspondingly, thereby increasing the cost of the controller.

As mentioned hereinabove, the photosensor has to detect the light emitting intensity of the LED and the detected result is then fed back for the purpose of adjusting the power of the LED in the above-mentioned methods. The cost of achieving the object of the prior art is very high. So, it is an important subject of the invention to provide a light emitting device capable of precisely controlling the luminance of the light emitting unit and reducing the cost.

### SUMMARY OF THE INVENTION

In view of the foregoing, the invention is to provide a light emitting device capable of precisely controlling the luminance of a light emitting unit and reducing the cost, and a control method thereof.

To achieve the above, the invention discloses a light emitting device, which includes at least one light emitting unit, a first switching unit, an energy storage unit, and an optical sensing-control unit. The first switching unit is electrically connected to the light emitting unit. The energy storage unit is electrically connected to the first switching unit and stores an electrical energy. The optical sensing-control unit is electrically connected to the energy storage unit, senses a light emitting energy of the light emitting unit and adjusts the electrical energy according to the light emitting energy. The first switching unit controls the light emitting unit according to the electrical energy.

To achieve the above, the invention further discloses a light emitting device, which includes at least one light emitting unit and an integrated circuit. The integrated circuit has a first switching unit, an optical sensing-control unit and an energy storage unit. The first switching unit is electrically connected to the light emitting unit. The energy storage unit is electrically connected to the first switching unit and stores an electrical energy. The optical sensing-control unit is electrically connected to the energy storage unit, senses a light emitting energy of the light emitting unit and adjusts the electrical energy according to the light emitting energy. The first switching unit controls the light emitting unit according to the electrical energy.

To achieve the above, the invention also discloses a method of controlling a light emitting device, which has at least one light emitting unit, a first switching unit, an energy storage unit and an optical sensing-control unit. The first switching unit is electrically connected to the light emitting unit. The energy storage unit is electrically connected to the first switching unit. The optical sensing-control unit is electrically connected to the energy storage unit. The method includes the following steps. First, an electrical energy is stored in the energy storage unit. Next, the first switching unit is turned on according to the electrical energy to enable the light emitting unit to emit light. Then, the optical sensing-control unit is enabled to sense a light emitting energy of the light emitting unit and to adjust the electrical energy stored in the energy storage unit. Finally, the first switching unit is turned off according to the electrical energy to disable the light emitting unit from emitting the light.

As mentioned above, the optical sensing-control unit receives the light of the light emitting unit and thus generates the leakage current to consume or adjust the electrical energy stored in the energy storage unit in the light emitting device and the control method thereof according to the invention. In addition, the light emitting unit is powered off after the electrical energy is completely consumed. Thus, it is possible to determine the light emitting time of the light emitting unit to control the total light emitting energy of the light emitting unit according to the electrical energy stored in the energy storage unit. In addition, the modularized integrated circuit can effectively decrease the number of elements and thus decrease the cost. In addition, the optical sensing-control unit has an optical sensing element, which can generate optical current when receiving the light emitted by the light emitting unit. Thus, the optical sensing-control unit can be used to adjust the electrical energy stored in the energy storage unit. Furthermore, a background reference generating circuit, which is not illuminated by the light emitting unit, can generate a background dark current reference level, so that the optical sensing-control unit can adjust the electrical energy stored in the energy storage unit according to the difference of the optical current and the background dark current reference level. Thus, the effect caused by the background dark current can be compensated. Alternatively, to compensate the background dark current while the comparator is operated, a threshold voltage generating circuit is configured to adjust the threshold voltage according to a background reference level. Accordingly, the comparator can determine the lighting period of the light emitting unit so as to control the accumulated light emitting energy of the light emitting unit. In other words, when the accumulated light emitting energy reaches a predetermined value, the first switching unit can control and disable the light emitting unit.

### BRIEF DESCRIPTION OF THE DRAWINGS

The invention will become more fully understood from the detailed description and accompanying drawings, which are given for illustration only, and thus are not limitative of the present invention, and wherein:

FIG. 1A is a schematic illustration showing a conventional architecture of adjusting the luminance of a LED;

FIG. 1B is a partial schematic illustration showing a conventional light emitting device;

FIG. 2 is a schematic block diagram showing a light emitting device according to a first embodiment of the invention;

FIGS. 3A and 3B are schematic block diagrams showing an integrated circuit, in which some components of the light emitting device according to the first embodiment of the invention are disposed;

FIG. 3C is a schematic block diagram showing a package, in which the integrated circuit of the light emitting device and the light emitting unit according to the first embodiment of the invention are disposed;

FIG. 4 is a graph showing a relationship between the light emitting time and the electrical energy stored in the energy storage unit of the light emitting device according to the first embodiment of the invention;

FIG. 5 is a schematic diagram showing an aspect of the connection in parallel between light emitting unit and the first switching unit of the light emitting device according to the first embodiment of the invention;

FIG. 6 is another schematic block diagram showing the light emitting device according to the first embodiment of the invention;

FIGS. 7A and 7B are schematic illustrations showing the light emitting device for performing a zoning control according to the first embodiment of the invention;

FIG. 8 is a schematic illustration showing a light emitting device according to a second embodiment of the invention;

FIG. 9 is another schematic illustration showing the light emitting device according to the second embodiment of the invention;

FIG. 10 is a flow chart showing a control method of the light emitting device according to the preferred embodiment of the invention;

FIG. 11A is a schematic illustration showing a light emitting device according to a third embodiment of the invention;

FIG. 11B is a schematic illustration showing another aspect of the light emitting device according to the third embodiment of the invention;

FIG. 12A is a schematic illustration showing still another aspect of the light emitting device according to the third embodiment of the invention;

FIG. 12B is a schematic illustration showing yet still another aspect of the light emitting device according to the third embodiment of the invention;

FIG. 13A is a schematic illustration showing a light emitting device according to a fourth embodiment of the invention;

FIGS. 13B and 13C are schematic illustrations showing another aspect of the light emitting device according to the fourth embodiment of the invention;

FIG. 14 is a schematic illustration showing still another aspect of the light emitting device according to the fourth embodiment of the invention; and

FIGS. 15A to 15C are schematic illustrations showing light emitting devices similar to that shown in FIG. 14 with different subtractors.

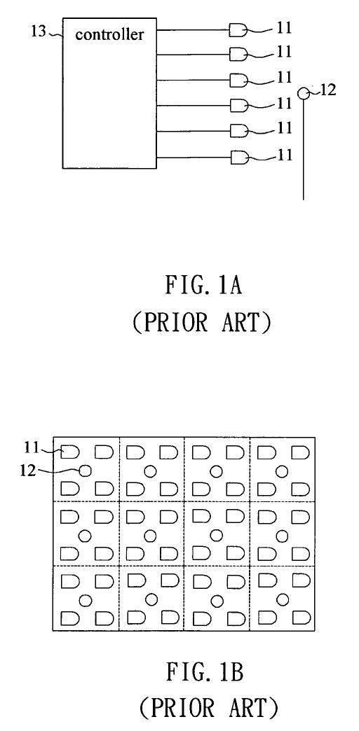

### DETAILED DESCRIPTION OF THE INVENTION

The present invention will be apparent from the following detailed description, which proceeds with reference to the accompanying drawings, wherein the same references relate to the same elements.

### First Embodiment

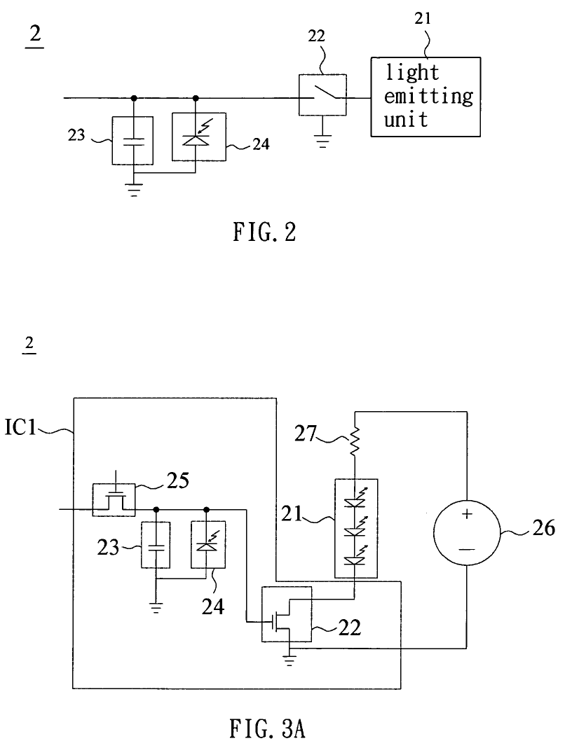

Referring to FIG. 2, a light emitting device 2 according to the first embodiment of the invention includes at least one light emitting unit 21, a first switching unit 22, an energy storage unit 23 and an optical sensing-control unit 24.

The light emitting unit 21 may include a cold cathode fluorescent lamp, a hot cathode fluorescent lamp or a LED (Light Emitting Diode). In this embodiment, the light emitting unit 21 is a LED, such as a white-light LED, a red LED, a green LED or a blue LED.

The first switching unit 22 is electrically connected to the light emitting unit 21. The first switching unit 22 may include a bipolar junction transistor (BJT) or a field effect transistor (FET). In this embodiment, the first switching unit 22 is a MOS (Metal Oxide Semiconductor) FET.

The energy storage unit 23 is electrically connected to the first switching unit 22 and stores an electrical energy. In this embodiment, the energy storage unit 23 is, for example, a charges storage unit, which includes a capacitor. The electrical energy is stored in the capacitor in the form of voltages. Of course, depending on different energy storage units, the electrical energy can be stored in energy storage unit in different form, such as current.

The optical sensing-control unit 24 is electrically connected to the energy storage unit 23, senses a light emitting energy of the light emitting unit 21, and adjusts the electrical energy according to the light emitting energy. The first switching unit 22 turns on and off according to the electrical energy stored in the energy storage unit 23 to enable and disable the light emitting unit 21. Herein, the first switching unit 22 turns on and off according to obvious change of the electrical energy. In this embodiment, the optical sensing-control unit 24 may include a photo diode connected in parallel with the energy storage unit 23. Of course, the optical sensing-control unit 24 may also include a control circuit, which is electrically connected to the photo diode for extra control.

It is to be noted that the electrical connection may be a direct electrical connection or an indirect electrical connection. The so-called indirect electrical connection means that two elements are electrically connected to each other through another element.

If the LED emits specific color light, the optical sensing-control unit 24 may further includes a color filter so that it can sense the light of specific wavelength. Corresponding to the wavelength, the color filter can be a red filter, a green filter, a blue filter or a white-light filter or an IR (Infrared Ray) filter.

As mentioned hereinabove, the total light emitting energy of the light emitting device 2 can be kept constant in this embodiment when the light emitting device 2 has either a single light emitting unit 21 or a plurality of light emitting units 21. The light emitting device 2 of the invention will be described in detail according to the circuit of FIG. 2. Symbol Q represents the charges stored in the capacitor (i.e., the charges stored in the energy storage unit 23). Symbol C represents the capacitance of the capacitor (i.e., the capacitance of the energy storage unit 23). Symbol V represents the crossover voltage of the capacitor (i.e., the crossover voltage of the energy storage unit 23); Symbol t represents the discharge time of the capacitor. Symbol α represents a known coefficient. Symbol I represents the current flowing through the optical sensing-control unit 24. Symbol L represents the light emitting power of the light emitting unit 21. Symbol E represents the total light emitting energy of the light emitting unit, and the equation of the total light emitting energy is derived as follows:

$$\begin{matrix}Q = I * t = C * V , & ( 1 ) \\ t = \frac{C * V}{I} , & ( 2 ) \\ I = α * L , and & ( 3 ) \\ E = L * t = \frac{C * V}{α} . & ( 4 )\end{matrix}$$

According to Equations (1) to (4), the current flowing through the optical sensing-control unit 24 is directly proportional to the light emitting power of the light emitting unit 21, and the capacitance of the capacitor is a constant value. So, the total light emitting energy of the light emitting unit 21 may be determined according to the crossover voltage (i.e., the voltage applied to the capacitor) of the capacitor. Thus, it is unnecessary to control the light emitting power of the light emitting unit 21 to maintain the light emitting energy. In other words, when the light emitting power of the light emitting unit 21 is greater, the optical sensing-control unit 24 enables the electrical energy stored in the capacitor to be consumed more rapidly. On the contrary, when the light emitting power of the light emitting unit 21 is smaller, the optical sensing-control unit 24 enables the electrical energy stored in the capacitor to be consumed more slowly. Thus, the effect of unifying the total light emitting energy of the light emitting unit 21 under different light emitting powers can be achieved.

Herein, it is to be specified that the optical sensing-control unit 24 senses the light emitting energy of the light emitting unit 21 to thereby consume the electrical energy of the capacitor in this embodiment. Alternately, it is also possible to adopt the optical sensing-control unit 24 to sense the light emitting energy of the light emitting unit 21 and thus to increase the electrical energy of the capacitor, wherein the symbol t represents the charging time. The optical sensing-control unit 24 can sense the light emitting energy of the light emitting unit 21 to thereby adjust the electrical energy of the capacitor.

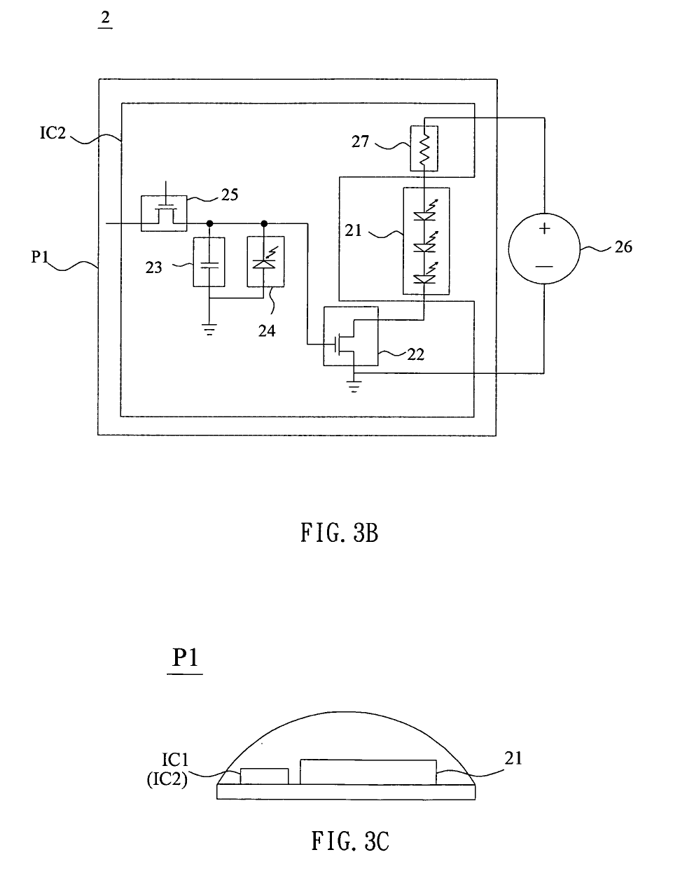

As shown in FIG. 3A, the light emitting device 2 may further include a second switching unit 25, a power supply unit 26 and a current-limiting unit 27. The second switching unit 25 is electrically connected to the energy storage unit 23, and the electrical energy can be inputted to the energy storage unit 23 by controlling the second switching unit 25. The power supply unit 26 is electrically connected to the light emitting unit 21 and provides a power to the light emitting unit 21. The current-limiting unit 27 is electrically connected to the power supply unit 26 and the light emitting unit 21 to restrict the power intensity of driving the light emitting unit 21 to emit light and thus prevent excessive power from damaging the light emitting unit 21. In this embodiment, the second switching unit 25 may be the same as the first switching unit 22 and include a bipolar transistor or a field effect transistor. The power supply unit 26, such as a voltage source or a current source, provides a DC power to the light emitting unit 21. The current-limiting unit 27 is a resistor.

In addition, at least two of the first switching unit 22, the energy storage unit 23, the optical sensing-control unit 24 and the second switching unit 25 in this embodiment may be disposed in an integrated circuit IC1, as shown in FIG. 3A. Furthermore, at least two of the first switching unit 22, the energy storage unit 23, the optical sensing-control unit 24, the second switching unit 25 and the current-limiting unit 27 may be disposed in an integrated circuit IC2, as shown in FIG. 3B. Furthermore, the light emitting unit 21 may also be disposed in the integrated circuit IC1 or IC2.

Moreover, in this embodiment, the light emitting device 2 may be a package P1, and the light emitting unit 21 and the integrated circuit IC1 or IC2 is disposed in the package P1, as shown in FIG. 3C. Because the package technology includes many package methods that are well known in the art, the method of packaging the package P1 is not particularly limited. It is to be noted that the light emitting device 2 may include, without being limited to, a single package, a backlight module, a typical illumination device, a LED display or any other light emitting device from any other field of technology.

The components disposed in the integrated circuit or package are not limited to the above mentioned aspect, and can be selected depending on the actual design. Of course, it is possible to dispose a plurality of first switching units 22, energy storage units 23, optical sensing-control units 24, second switching units 25, current-limiting units 27 or control circuits in a single integrated circuit or package.

The use of the integrated circuit or the package can modularize the light emitting device 2, enable the optical sensing-control unit 24 to receive the light generated by the light emitting unit 21 more precisely, and thus decrease the interference of ambient light.

As shown in FIG. 3B again, when the second switching unit 25 turns on, the light emitting device 2 inputs the electrical energy (voltage) to the energy storage unit 23 through the second switching unit 25. When the electrical energy stored in the energy storage unit 23 is sufficient to turn on the first switching unit 22, the light emitting unit 21 lights as the first switching unit 22 turns on. Meanwhile, the optical sensing-control unit 24 receives the light generated by the light emitting unit 21 and starts to leak the current and consume the electrical energy stored in the energy storage unit 23. In this embodiment, the optical sensing-control unit 24 discharges the electrical energy with a constant current to consume the electrical energy and with a discharge rate directly proportional to the luminance of the light emitting unit 21. In addition, as the light emitting energy of the light emitting unit 21 gets stronger, the optical sensing-control unit 24 consumes the electrical energy more quickly. After the electrical energy is consumed (i.e., the voltage drops below the turn-on threshold voltage of the first switching unit 22), the first switching unit 22 immediately turns off and the light emitting unit 21 also stops emitting light when the first switching unit 22 is turned off.

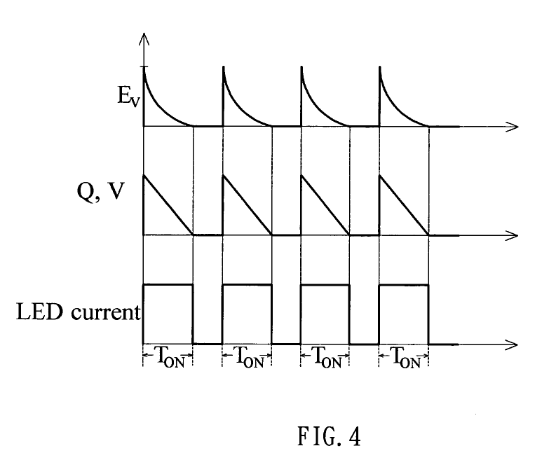

As shown in FIG. 4, the light emitting time T_{ON} of the light emitting unit 21 changes with the change of the electrical energy E_{V} stored in the energy storage unit 23. The electrical energy E_{V} can be calculated with reference to the following equation:

$${E}_{V} = \frac{Q \times V}{2} = \frac{C \times {V}^{2}}{2}$$

Thus, controlling the electrical energy E_{V} stored in the energy storage unit 23 can control the average luminance of the light emitting unit 21. For example, increasing the electrical energy stored in the energy storage unit 23 by increasing the voltage, can correspondingly increase the discharge time of the optical sensing-control unit 24 and thus lengthen the light emitting time of the light emitting unit 21.

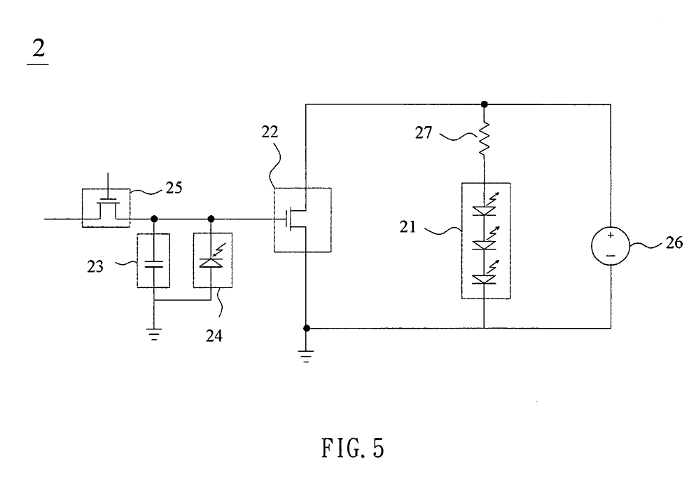

In the previous illustrations, the first switching unit 22 and the light emitting unit 21 are connected in series. In addition, as shown in FIG. 5, the first switching unit 22 and the light emitting unit 21 can be connected in parallel. In this case, the optical sensing-control unit 24 can also sense the light emitting energy of the light emitting unit 21 so as to adjust the electrical energy stored in the capacitor, thereby controlling the light emitting unit 21.

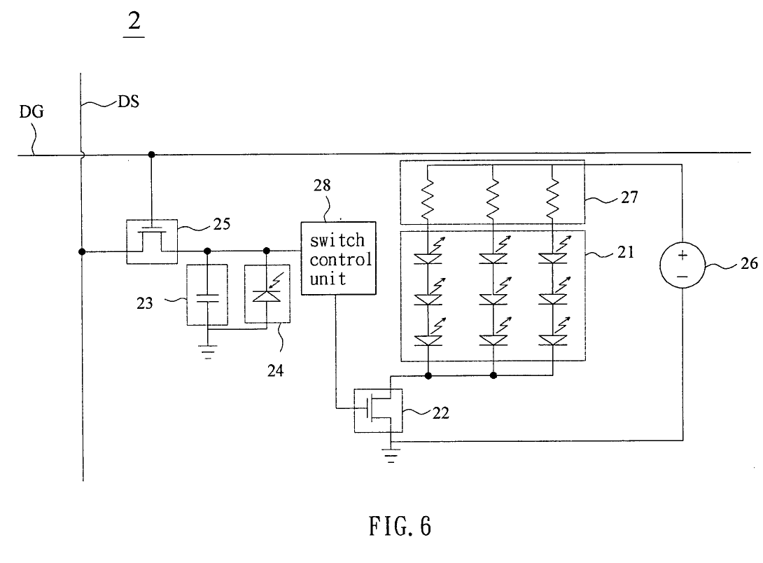

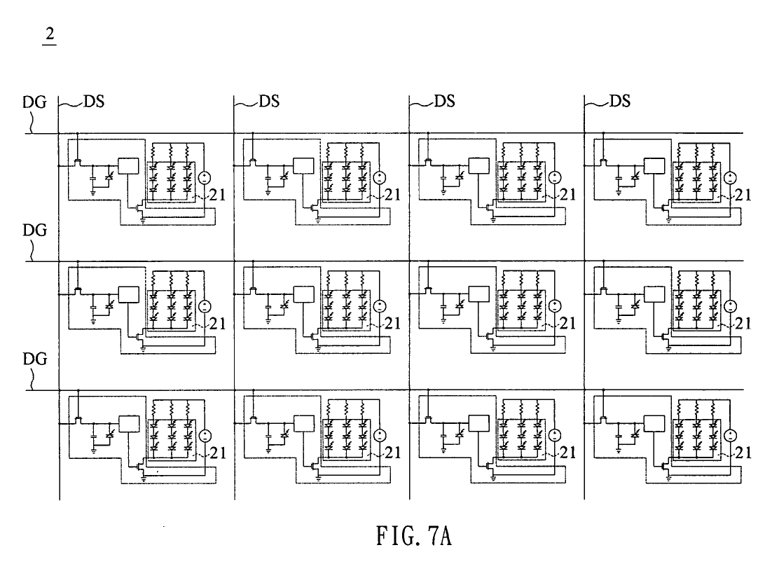

In addition, as shown in FIG. 6, the light emitting unit 21 of this embodiment may further include three sets of LEDs electrically connected to each other in parallel. The current-limiting unit 27 includes three corresponding resistors electrically connected to the three sets of LEDs. The three sets of LEDs may include red LEDs, green LEDs and blue LEDs or other LEDs with other colors.

Furthermore, the light emitting device 2 of this embodiment may further include a switch control unit 28, a row driving circuit DG and a column driving circuit DS.

The switch control unit 28 is electrically connected to the first switching unit 22 and the energy storage unit 23 and generates a control signal to control the first switching unit 22 to turn on and off according to the electrical energy stored in the energy storage unit 23. Of course, the switch control unit 28 may also be disposed in the integrated circuit IC1 or IC2.

The row driving circuit DG is electrically connected to the second switching unit 25 to control ON/OFF of the second switching unit 25 and the column driving circuit DS is also electrically connected to the second switching unit 25 so that the electrical energy can be inputted to the energy storage unit 23 through the second switching unit 25 when the second switching unit 25 is ON. In this embodiment, because the second switching unit 25 may be a MOS field effect transistor, the row driving circuit DG may be a gate driving circuit and is electrically connected to the gate of the second switching unit 25. The column driving circuit DS may be a source driving circuit and is electrically connected to the source of the second switching unit 25.

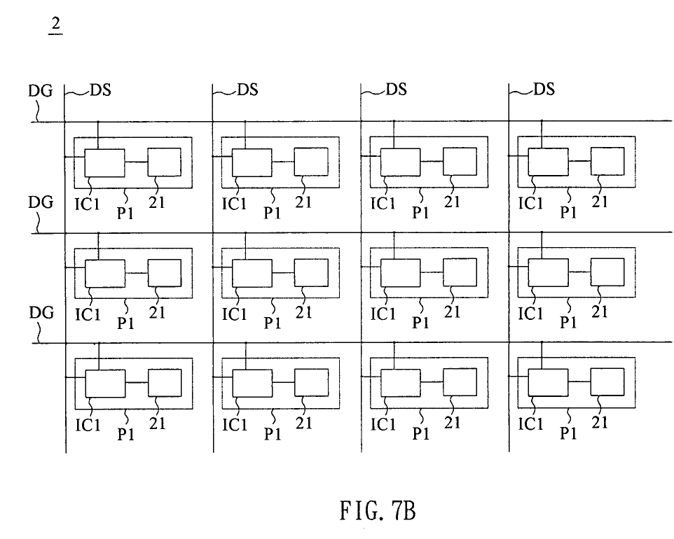

As shown in FIG. 7A, when the light emitting device 2 of the embodiment has a plurality of sets of light emitting units 21, the column driving circuits DS and the row driving circuits DG may be disposed in columns and rows and thus electrically connected to the second switching unit 25 to thus control the light emitting unit 21. For example, when the light emitting device 2 is divided into 12 zones for control, i.e., the light emitting device 2 has 12 sets of light emitting units 21, it is possible to use three sets of row driving circuits DG and four sets of column driving circuits DS to control the 12 zones of the second switching unit 25 and thus control the light emitting unit 21. Thus, the required control chip only needs seven channels to control the light emitting unit 21 of the 12 zones. In addition, the power supply unit 26 of this architecture may be shared.

As macroscopically shown in FIG. 7B, the package PI, the row driving circuit DG and the column driving circuit DS cooperate with one another and the integrated circuit IC1 and the light emitting unit 21 are disposed in the package PI.

### Second Embodiment

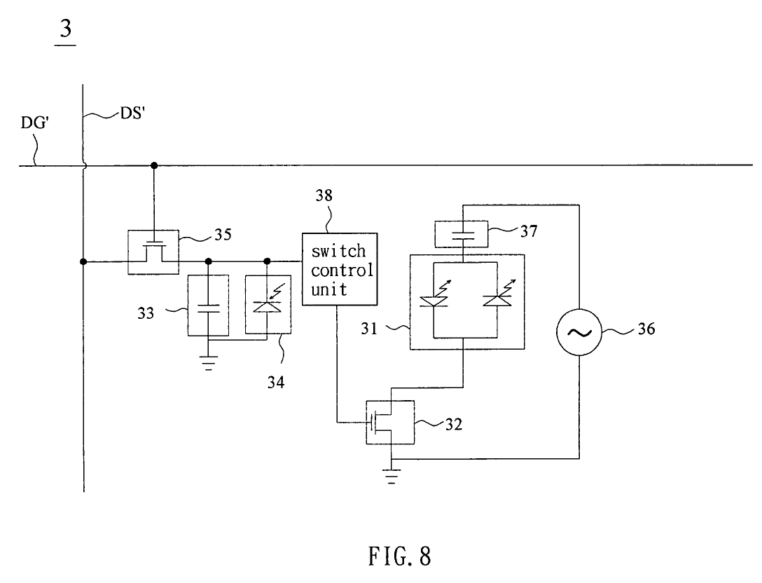

Referring to FIG. 8, a light emitting device 3 according to a second embodiment of the invention includes a light emitting unit 31, a first switching unit 32, an energy storage unit 33, an optical sensing-control unit 34, a second switching unit 35, a power supply unit 36, a current-limiting unit 37, a switch control unit 38, a row driving circuit DG′ and a column driving circuit DS′.

The energy storage unit 33, the optical sensing-control unit 34, the second switching unit 35, the switch control unit 38, the row driving circuit DG′ and the column driving circuit DS′ have the same structures and functions as those of the energy storage unit 23, the optical sensing-control unit 24, the second switching unit 25, the switch control unit 28, the row driving circuit DG and the column driving circuit DS according to the first embodiment of the invention, so detailed descriptions thereof will be omitted.

It is also of note that at least two of the light emitting unit 31, the first switching unit 32, the energy storage unit 33, the optical sensing-control unit 34, the second switching unit 35 and the switch control unit 38 may be disposed in one integrated circuit (not shown).

The difference between the first and second embodiments is that the light emitting unit 31 includes a diode ring formed by at least two LEDs, the power supply unit 36 provides an AC power to drive the LEDs in a positive half cycle and a negative half cycle of the AC power, and the current-limiting unit 37 is a capacitor in the second embodiment. The capacitor does not consume power in the circuit and thus can decrease the power consumption in the circuit to enhance the efficiency. Of course, the current-limiting unit 37 may also be an inductor in another circuit architecture.

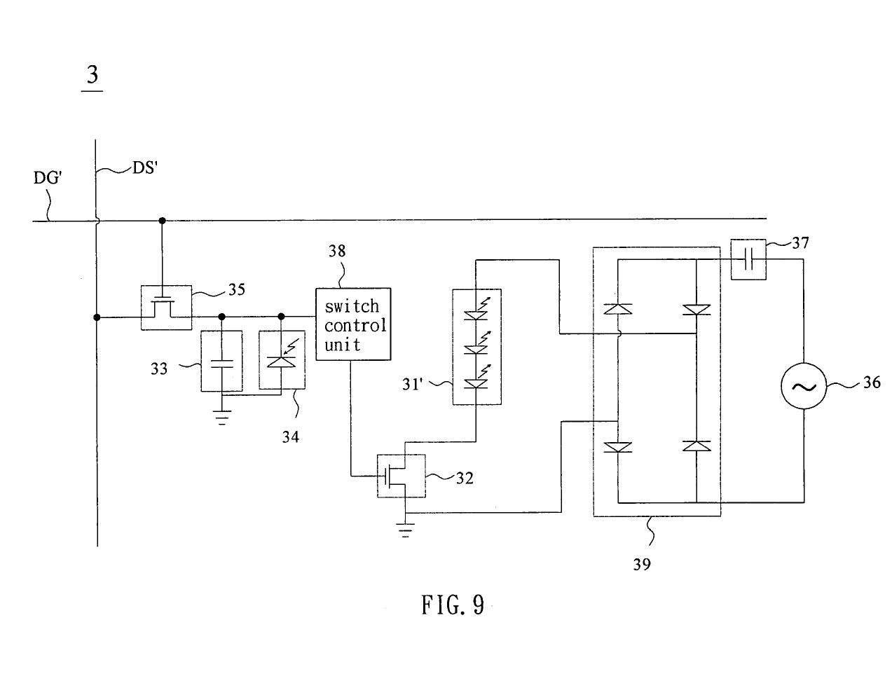

In addition, FIG. 9 shows another aspect of the light emitting device 3 according to the second embodiment of the invention, wherein the power supply unit 36 also generates AC power, the light emitting unit 31′ includes a LED or a plurality of LEDs electrically connected in series, and a rectifying unit 39 is electrically connected to the current-limiting unit 37 and the light emitting unit 31′. In this embodiment, the rectifying unit 39 is a full-bridge rectifying circuit for transforming AC power into DC power and inputting the DC power to the light emitting unit 31′. Consequently, the current-limiting unit 37 still may be a capacitor, which does not consume real power in the circuit, such that the power consumption may be reduced and the efficiency may be enhanced.

### Third Embodiment

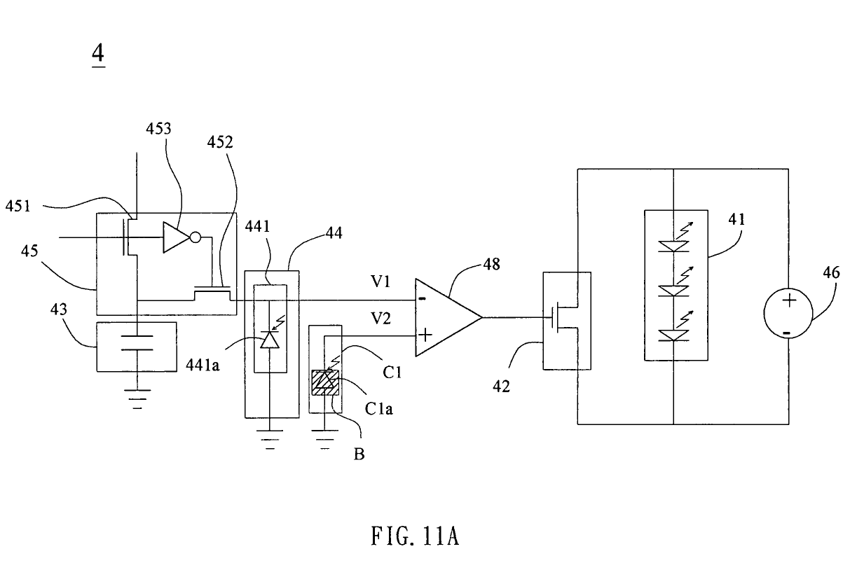

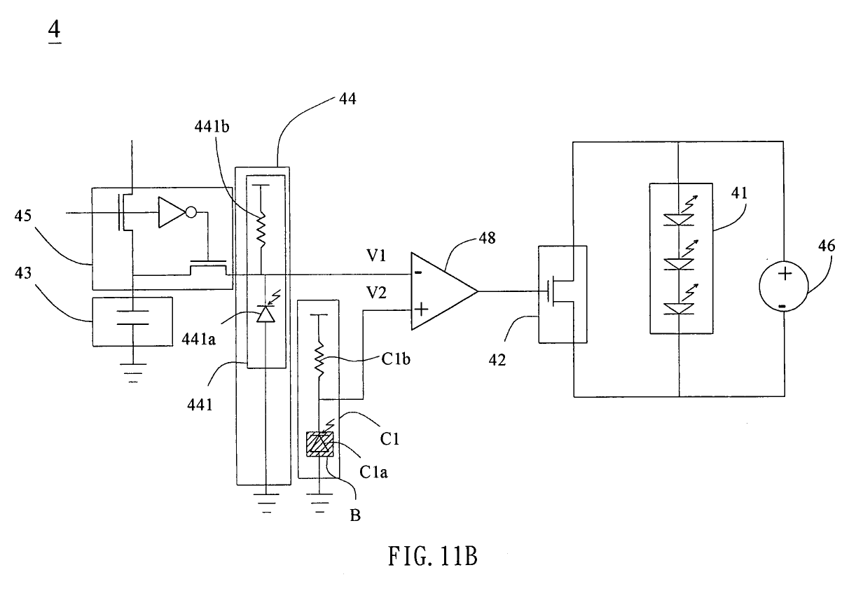

With reference to FIG. 11A, a light emitting device 4 according to a third embodiment of the invention is different from that of the previously mentioned embodiments in that: the switch control unit 48 includes a comparator and the optical sensing-control unit 44 includes an optical sensing circuit 441, which senses the light emitting energy of the light emitting unit 41. Then, the optical sensing-control unit 44 adjusts the electrical energy and a corresponding voltage V1. In addition, when the optical sensing circuit 441 is not illuminated by the light emitted from the light emitting unit 41, it also senses the environment temperature so as to generate a background dark current and thus consumes the electrical energy and the corresponding voltage V1. Then, the switch control unit 48 compares the voltage V1 with a threshold voltage V2, and the switching unit 42 controls the light emitting unit 41 according to the comparing result.

In the embodiment, the threshold voltage V2 is provided by a threshold voltage generating circuit C1, which includes a background reference level element C1a. The optical sensing circuit 441 includes an optical sensing element 441a.

The optical sensing element 441a includes a photo diode or a photo-sensitive resistor, and the background reference level element C1a also includes a photo diode or a photo-sensitive resistor. In the embodiment, the optical sensing element 441a and the background reference level element C1a are both photo diodes. The optical sensing element 441a and the background reference level element C1a are the same elements, while the background reference level element C1a is not illuminated by the light so that it is not activated due to the light emitting energy of the light emitting unit 41. Furthermore, the light emitting device 4 of this embodiment further includes a shielding unit B, which shields the background reference level element C1a. The shielding unit B is made of, for example, metal, polysilicon or light-shielding ink, and can be formed by a semiconductor manufacturing process.

The second switching unit 45 includes a bipolar transistor, a MIOSFET (metal oxide semiconductor field effect transistor) and/or an inverter. In the embodiment, the second switching unit 45 includes a MOSFET 451, a MOSFET 452 and an inverter 453, is electrically connected to the energy storage unit 43 and the optical sensing-control unit 44. When the MOSFET 451 is turned on, the charges can be inputted into the energy storage unit 43. Otherwise, when the MOSFET 451 is turned off, the switching signal is processed by the inverter 453 so that the MOSFET 452 can be turned on. Then, the electrical energy stored in the energy storage unit 43 is inputted into the optical sensing-control unit 44.

Therefore, the optical sensing circuit 441 can not only generate optical current by sensing the light emitting energy of the light emitting unit 41, but also generate the background dark current due to the environment temperature. Then, the optical sensing circuit 441 can generate the voltage V1 according to the sum of the optical and dark currents, and the threshold voltage generating circuit C1 can generate the threshold voltage V1 according to the dark current only.

Accordingly, the switch control unit 48 can compare the voltage V1 generated by the optical sensing circuit 441 and the voltage V2 generated by the threshold voltage generating circuit C1 so as to eliminate the effect of the dark current. Then, the switching element 421 of the first switching unit 42 can be controlled by the switch control unit 48 so as to control the light emitting unit 41.

With reference to FIG. 11B, in this embodiment, the optical sensing circuit 441 may further include a resistor 441b connected to the optical sensing circuit 441 in series, and the threshold voltage generating circuit C1 may further include a resistor 442b connected to threshold voltage generating circuit C1 in series. Accordingly, the optical sensing circuit 441 and the threshold voltage generating circuit C1 can carry out the function of a voltage divider.

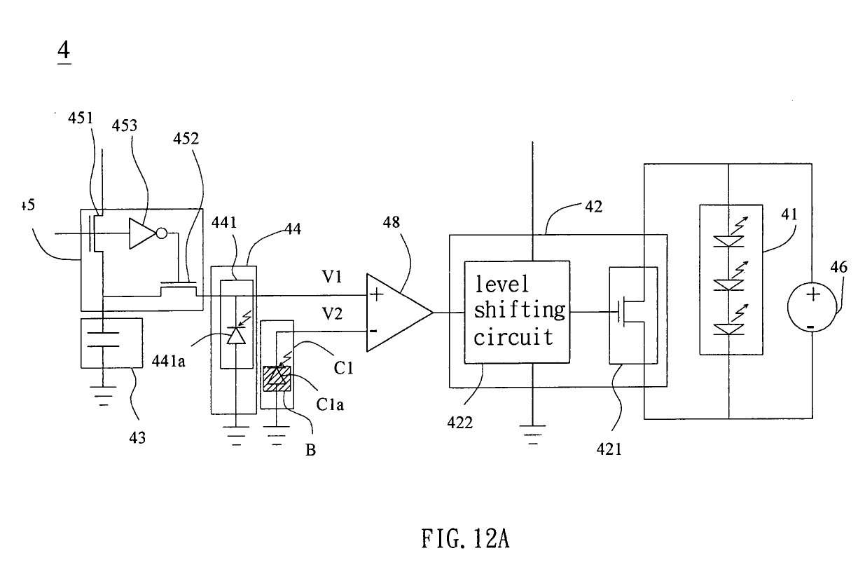

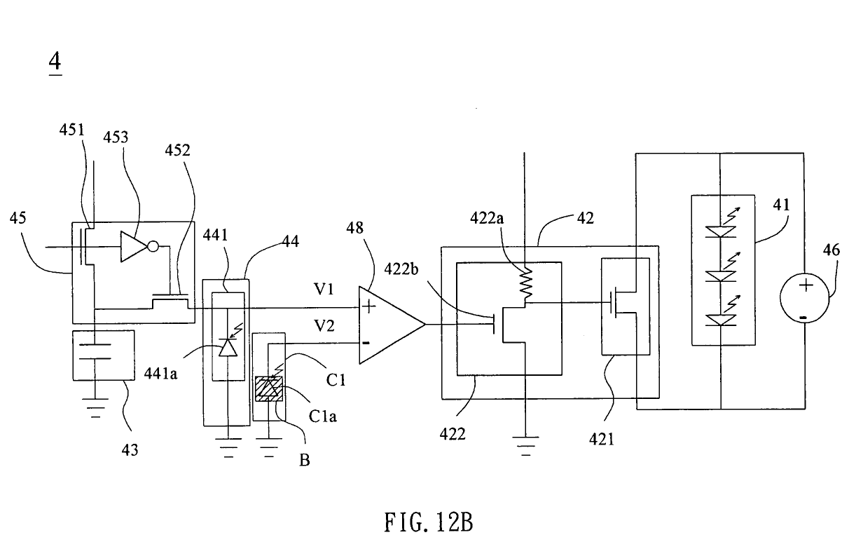

With reference to FIG. 12A, the first switching unit 42 of the embodiment includes a switching element 421 and a level shifting circuit 422 electrically connected to the switching element 421. The level shifting circuit 422 includes a resistor, a bipolar transistor and/or a MOSFET. The level shifting circuit 422 can raise the voltage level, which is then inputted into the switching element 421, and filter the noise of the inputted signal, so that the switching unit 42 can response much more sensitively. In addition, as shown in FIG. 12B, one design aspect of the level shifting circuit 422 may be composed of a resistor 422a and a MOSFET 422b, which are connected in series.

To be noted, the design aspect of the level shifting circuit 422 is, for example but not limited to, those described according to the embodiment, and it can be any design that can achieve the required functions.

### Fourth Embodiment

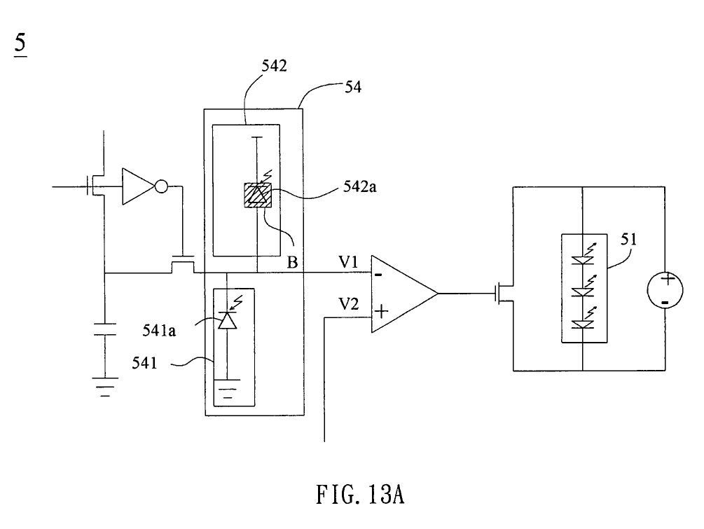

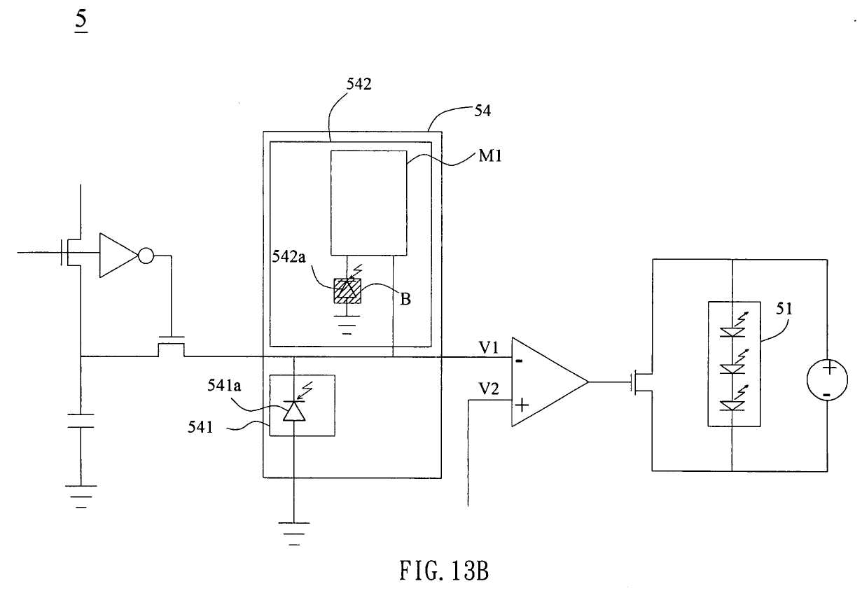

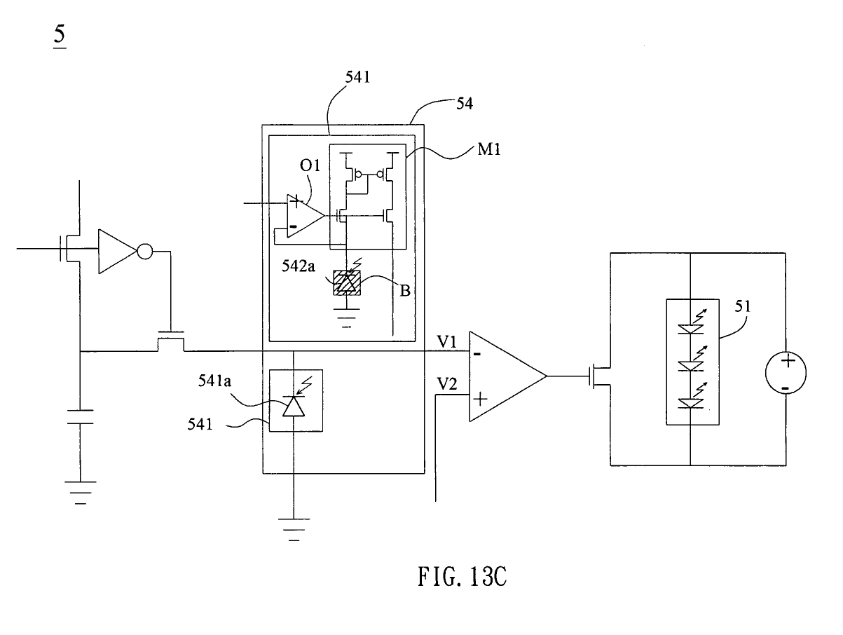

With reference to FIG. 13A, a light emitting device 5 according to a fourth embodiment of the invention is different from that of the third embodiment in that: the threshold voltage V2 is preset, and the optical sensing-control unit 54 includes a background reference generating circuit 542 for generating a background reference level signal. The optical sensing-control unit 54 further compensates the effect due to the background dark current according to the background reference level signal. In the embodiment, the background reference generating circuit 542 includes a background reference level element 542a, which is the same as the background reference level element C1a of the third embodiment. Thus, the detailed descriptions are omitted.

Then, a voltage V1, which is generated by a voltage divider formed by the optical sensing element 541a and background reference level element 542a, is compared with the threshold voltage V2, so that the effect of the background dark current caused by the environment temperature can be eliminated.

Referring to FIG. 13B, the background reference level element 542a can connect with a current mirror M1 for duplicating the dark current. As shown in FIG. 13C, to control the bias voltage of the background reference level element 542a, the current mirror M1 may further connect to an operational amplifier O1. To be noted, the design aspect of the current mirror M1 is, for example but not limited to, those described according to the embodiment, and it can be any design that can optimize the performance of the entire circuits.

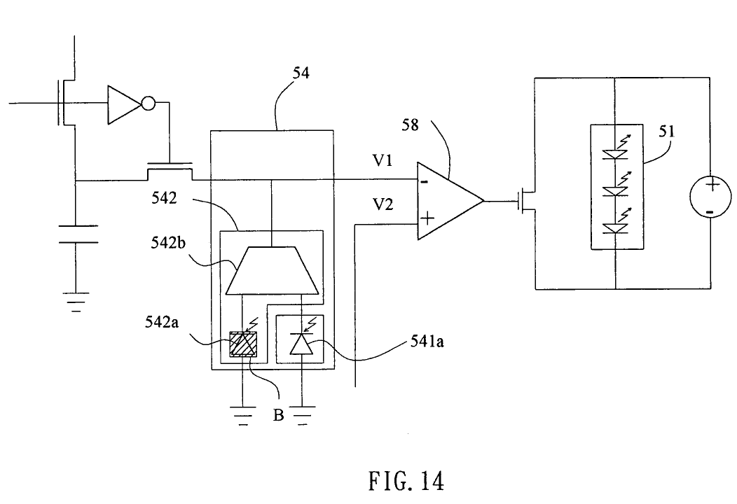

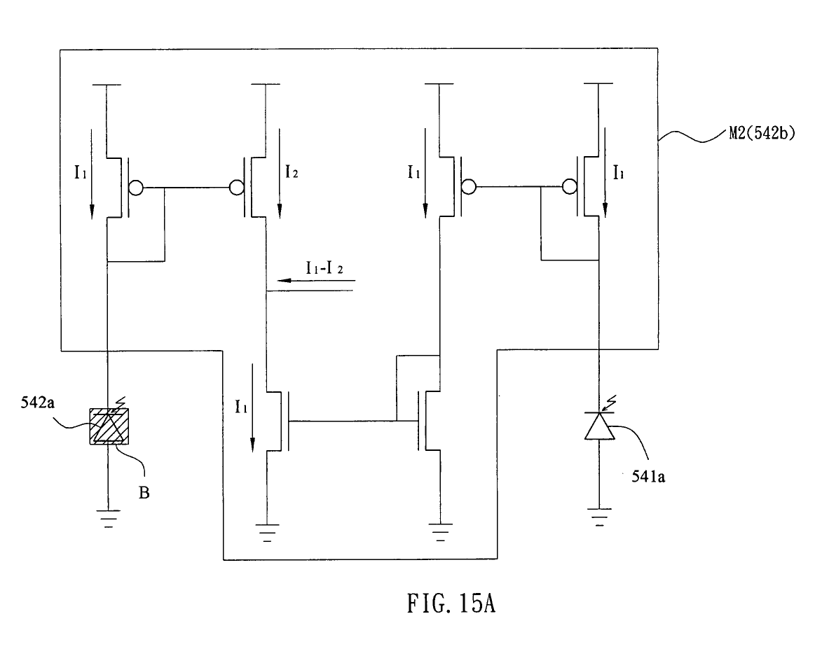

With reference to FIG. 14, in another aspect of the light emitting unit 5, the background reference generating circuit 542 of the optical sensing-control unit 54 further includes a current subtractor 542b, which is electrically connected with the optical sensing element 541a and the background reference level element 542a, for eliminating the background dark current.

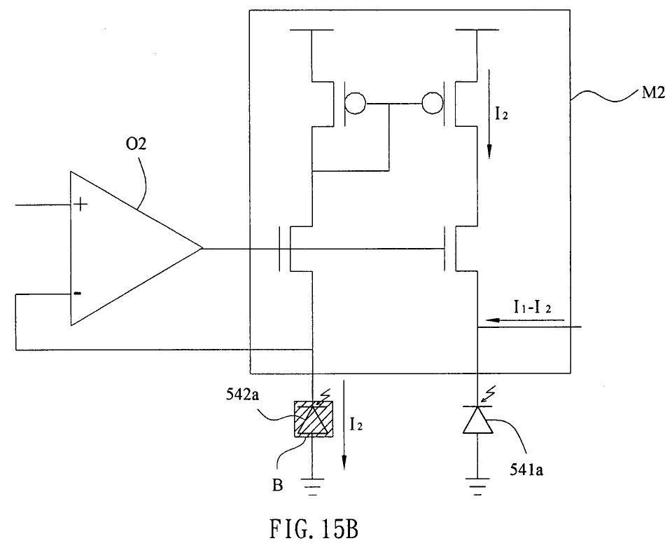

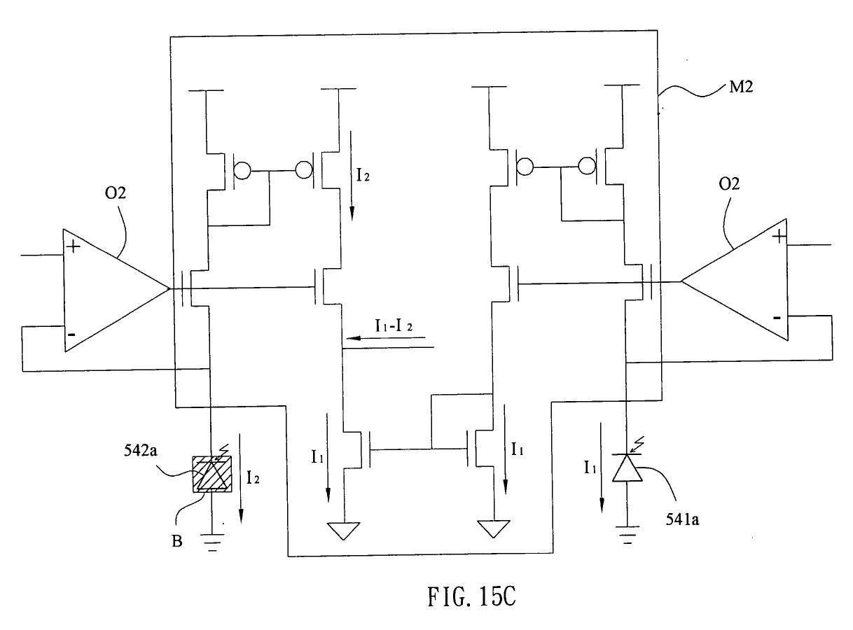

Then, as shown in FIGS. 15A to 15C, the current subtractor 542b can be designed in different aspects, which composed of a current mirror M2 and an operational amplifier O2. Herein, the currents I₁ and I₂ represent the currents flowing through the photo diodes in the optical sensing element 541a and the background reference level element 542a, respectively. To be noted, the design aspect of the current subtractor 542b is, for example but not limited to, those described according to the embodiment, and it can be any design that can optimize the performance of the entire circuits.

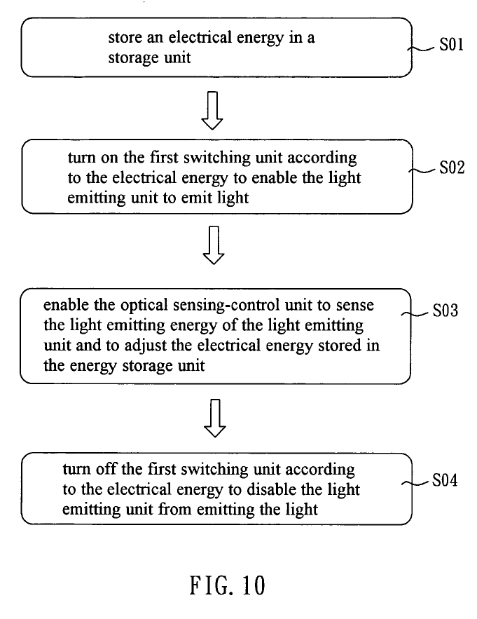

Referring to FIG. 10, a method of controlling the light emitting device according to the preferred embodiment of the invention includes the following steps. Step S01 is to store an electrical energy in a storage unit. Step S02 is to turn on the first switching unit according to the electrical energy to enable the light emitting unit to emit light. Step S03 is to enable the optical sensing-control unit to sense the light emitting energy of the light emitting unit and to adjust the electrical energy stored in the energy storage unit. Step S04 is to turn off the first switching unit according to the electrical energy to disable the light emitting unit from emitting the light. Because the detailed control method has been described in the above-mentioned embodiments, detailed descriptions thereof will be omitted.

In summary, the optical sensing-control unit receives the light of the light emitting unit and thus generates the leakage current to consume or adjust the electrical energy stored in the energy storage unit in the light emitting device and the control method thereof according to the invention. In addition, the light emitting unit is powered off after the electrical energy is completely consumed. Thus, it is possible to determine the light emitting time of the light emitting unit to control the total light emitting energy of the light emitting unit according to the electrical energy stored in the energy storage unit. In addition, the column-to-row control method can reduce the number of channels required to control the chip, and the cost of the light emitting device may be thus reduced. Furthermore, a current-limiting element in conjunction with the AC power can also effectively decrease the real power consumption. In addition, the optical sensing-control unit has an optical sensing element, which can generate optical current when receiving the light emitted by the light emitting unit. Thus, the optical sensing-control unit can be used to adjust the electrical energy stored in the energy storage unit. Furthermore, a background reference level circuit, which is not illuminated by the light emitting unit, can generate a background dark current reference level, so that the optical sensing-control unit can adjust the electrical energy stored in the energy storage unit according to the difference of the optical current and the background dark current reference level. Thus, the effect caused by the background dark current can be compensated. Alternatively, to compensate the background dark current while the comparator is operated, a threshold voltage generating circuit is configured to adjust the threshold voltage according to a background reference level. Accordingly, the comparator can determine the lighting period of the light emitting unit so as to control the accumulated light emitting energy of the light emitting unit. In other words, when the accumulated light emitting energy reaches a predetermined value, the first switching unit can control and disable the light emitting unit.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

1. A light emitting device, comprising:
at least one light emitting unit;
at least a first switching unit electrically connected to the light emitting unit;
at least an energy storage unit, which is electrically connected to the first switching unit and stores an electrical energy; and
at least an optical sensing-control unit, which is electrically connected to the energy storage unit, senses a light emitting energy of the light emitting unit and adjusts the electrical energy according to the light emitting energy, wherein the first switching unit controls the light emitting unit according to the electrical energy.

2. The light emitting device according to claim 1, wherein the energy storage unit is a charges storage unit.

3. The light emitting device according to claim 2, wherein the charges storage unit comprises a capacitor.

4. The light emitting device according to claim 1, further comprising:
a switch control unit electrically connected with the energy storage unit and the first switching unit and generating a control signal to control the first switching unit according to the electrical energy.

5. The light emitting device according to claim 4, wherein the switch control unit comprises a comparator.

6. The light emitting device according to claim 4, wherein at least two of the light emitting unit, the energy storage unit, the optical sensing-control unit, the first switching unit and the switch control unit are disposed in an integrated circuit.

7. The light emitting device according to claim 5, wherein the optical sensing-control unit adjusts the electrical energy and a corresponding voltage, the comparator compares the voltage and a threshold voltage, and the first switching unit controls the light emitting unit according to the comparing result.

8. The light emitting device according to claim 7, wherein the optical sensing-control unit comprises an optical sensing circuit for sensing a light emitting energy of the light emitting unit, and the optical sensing-control unit adjusts the electrical energy and the corresponding voltage according to the light emitting energy.

9. The light emitting device according to claim 8, wherein the optical sensing circuit comprises an optical sensing element.

10. The light emitting device according to claim 9, wherein the optical sensing element is a photo diode or a photo-sensitive resistor.

11. The light emitting device according to claim 9, wherein the optical sensing-control unit further comprises a background reference generating circuit for generating a background reference level signal, and the optical sensing-control unit further compensates the effect due to a background dark current according to the background reference level signal.

12. The light emitting device according to claim 11, wherein the background reference generating circuit comprises a background reference level element.

13. The light emitting device according to claim 11, wherein each of the optical sensing circuit and the background reference generating circuit comprises a resistor.

14. The light emitting device according to claim 7, wherein the threshold voltage is preset or is generated by a threshold voltage generating circuit.

15. The light emitting device according to claim 14, wherein the threshold voltage generating circuit comprises a background reference level element.

16. The light emitting device according to claim 1, wherein the background reference level element is a photo diode or a photo-sensitive resistor.

17. The light emitting device according to claim 1, wherein the optical sensing element and the background reference level element are the same kind of elements, and the background reference level element is shielded and is not excited by the light emitting energy of the light emitting unit.

18. The light emitting device according to claim 16, further comprising:
a shielding unit shielding the background reference level element.

19. The light emitting device according to claim 18, wherein the shielding unit is formed by a semiconductor manufacturing process.

20. The light emitting device according to claim 18, wherein the shielding unit is made of metal, polysilicon or light-shielding ink.

21. The light emitting device according to claim 1, wherein the optical sensing-control unit further comprises a current subtractor or a current mirror.

22. The light emitting device according to claim 8, wherein the optical sensing-control unit further comprises a color filter disposed adjacent to the optical sensing circuit.

23. The light emitting device according to claim 22, wherein the color filter is a red filter, a green filter, a blue filter, a white-light filter or an IR (Infrared Ray) filter.

24. The light emitting device according to claim 1, wherein the light emitting unit comprises a light emitting diode (LED).

25. The light emitting device according to claim 1, wherein the first switching unit comprises a switching element.

26. The light emitting device according to claim 25, wherein the switching element comprises a bipolar transistor or a field effect transistor.

27. The light emitting device according to claim 25, wherein the first switching unit further comprises a level shifting circuit electrically connected with the switching element.

28. The light emitting device according to claim 27, wherein the level shifting circuit comprises a resistor, a bipolar transistor and/or a field effect transistor (FET).

29. The light emitting device according to claim 1, which is assembled as a package.

30. The light emitting device according to claim 1, wherein at least two of the light emitting unit, the energy storage unit, the optical sensing-control unit and the first switching unit are disposed in an integrated circuit.

31. The light emitting device according to claim 1, further comprising:
a second switching unit electrically connected to the energy storage unit, wherein the electrical energy is input to the energy storage unit through the second switching unit.

32. The light emitting device according to claim 31, wherein at least two of the light emitting unit, the energy storage unit, the optical sensing-control unit, the first switching unit and the second switching unit are disposed in an integrated circuit.

33. The light emitting device according to claim 31, wherein the second switching unit comprises a bipolar transistor, a field effect transistor (FET), a MOSFET and/or an inverter.

34. The light emitting device according to claim 31, further comprising:
a row driving circuit, which is electrically connected to the second switching unit, for controlling the second switching unit to turn on and off; and
a column driving circuit, which is electrically connected to the second switching unit, for inputting the electrical energy to the energy storage unit.

35. The light emitting device according to claim 1, further comprising:
a power supply unit, which is electrically connected to the light emitting unit and supplies a power to the light emitting unit.

36. The light emitting device according to claim 35, wherein the power is a DC power or an AC power.

37. The light emitting device according to claim 35, further comprising a current-limiting unit, which is electrically connected to the power supply unit and the light emitting unit.

38. The light emitting device according to claim 37, wherein at least two of the light emitting unit, the energy storage unit, the optical sensing-control unit, the first switching unit and the current-limiting unit are disposed in an integrated circuit.

39. The light emitting device according to claim 37, wherein the current-limiting unit is a resistor, a capacitor or and inductor.

40. The light emitting device according to claim 35, further comprising a rectifying unit electrically connected to the light emitting unit and the power supply unit.

41. The light emitting device according to claim 40, wherein the rectifying unit is a full-bridge rectifying circuit.

42. The light emitting device according to claim 1, wherein the optical sensing-control unit and the energy storage unit are connected in parallel.

43. The light emitting device according to claim 1, wherein the first switching unit and the light emitting unit are connected in parallel.

44. The light emitting device according to claim 1, wherein the first switching unit and the light emitting unit are connected in series.

45. A light emitting device, comprising:
at least one light emitting unit; and
an integrated circuit having at least a first switching unit, at least an optical sensing-control unit and at least an energy storage unit, wherein:
the first switching unit is electrically connected to the light emitting unit,
the energy storage unit is electrically connected to the first switching unit and stores an electrical energy,
the optical sensing-control unit is electrically connected to the energy storage unit, senses a light emitting energy of the light emitting unit and adjusts the electrical energy according to the light emitting energy, and
the first switching unit controls the light emitting unit according to the electrical energy.

46. The light emitting device according to claim 45, wherein the energy storage unit is a charges storage unit.

47. The light emitting device according to claim 46, wherein the charges storage unit comprises a capacitor.

48. The light emitting device according to claim 45, wherein the integrated circuit further comprises:
a switch control unit electrically connected with the energy storage unit and the first switching unit and generating a control signal to control the first switching unit according to the electrical energy.

49. The light emitting device according to claim 48, wherein the switch control unit comprises a comparator.

50. The light emitting device according to claim 49, wherein the optical sensing-control unit adjusts the electrical energy and a corresponding voltage, the comparator compares the voltage and a threshold voltage, and the first switching unit controls the light emitting unit according to the comparing result.

51. The light emitting device according to claim 50, wherein the optical sensing-control unit comprises an optical sensing circuit for sensing a light emitting energy of the light emitting unit, and the optical sensing-control unit adjusts the electrical energy and the corresponding voltage according to the light emitting energy.

52. The light emitting device according to claim 51, wherein the optical sensing circuit comprises an optical sensing element.

53. The light emitting device according to claim 52, wherein the optical sensing element is a photo diode or a photo-sensitive resistor.

54. The light emitting device according to claim 52, wherein the optical sensing-control unit further comprises a background reference generating circuit for generating a background reference level signal, and the optical sensing-control unit further compensates the effect due to a background dark current according to the background reference level signal.

55. The light emitting device according to claim 54, wherein the background reference generating circuit comprises a background reference level element.

56. The light emitting device according to claim 54, wherein each of the optical sensing circuit and the background reference generating circuit comprises a resistor.

57. The light emitting device according to claim 50, wherein the threshold voltage is preset or is generated by a threshold voltage generating circuit.

58. The light emitting device according to claim 57, wherein the threshold voltage generating circuit comprises a background reference level element.

59. The light emitting device according to claim 45, wherein the background reference level element is a photo diode or a photo-sensitive resistor.

60. The light emitting device according to claim 45, wherein the optical sensing element and the background reference level element are the same kind of elements and the background reference level element is shielded and is not excited by the light emitting energy of the light emitting unit.

61. The light emitting device according to claim 59, further comprising:
a shielding unit shielding the background reference level element.

62. The light emitting device according to claim 61, wherein the shielding unit is formed by a semiconductor manufacturing process.

63. The light emitting device according to claim 61, wherein the shielding unit is made of metal, polysilicon or light-shielding ink.

64. The light emitting device according to claim 45, wherein the optical sensing-control unit further comprises a current subtractor or a current mirror.

65. The light emitting device according to claim 51, wherein the optical sensing-control unit further comprises a color filter disposed adjacent to the optical sensing circuit.

66. The light emitting device according to claim 65, wherein the color filter is a red filter, a green filter, a blue filter, a white-light filter or an IR (Infrared Ray) filter.

67. The light emitting device according to claim 45, wherein the light emitting unit comprises a light emitting diode (LED).

68. The light emitting device according to claim 45, wherein the first switching unit comprises a switching element.

69. The light emitting device according to claim 68, wherein the switching element comprises a bipolar transistor or a field effect transistor.

70. The light emitting device according to claim 68, wherein the first switching unit further comprises a level shifting circuit electrically connected with the switching element.

71. The light emitting device according to claim 70, wherein the level shifting circuit comprises a resistor, a bipolar transistor and/or a field effect transistor (FET).

72. The light emitting device according to claim 45, wherein the integrated circuit further comprises:
a second switching unit electrically connected to the energy storage unit, wherein the electrical energy is input to the energy storage unit through the second switching unit.

73. The light emitting device according to claim 72, wherein the second switching unit comprises a bipolar transistor, a field effect transistor (FET), a MOSFET and/or an inverter.

74. The light emitting device according to claim 72, further comprising:
a row driving circuit, which is electrically connected to the second switching unit, for controlling the second switching unit to turn on and off; and
a column driving circuit, which is electrically connected to the second switching unit, for inputting the electrical energy to the energy storage unit.

75. The light emitting device according to claim 45, further comprising:
a power supply unit, which is electrically connected to the light emitting unit and supplies a power to the light emitting unit.

76. The light emitting device according to claim 75, wherein the power is a DC power or an AC power.

77. The light emitting device according to claim 75, wherein the integrated circuit further comprises a current-limiting unit, which is electrically connected to the power supply unit and the light emitting unit.

78. The light emitting device according to claim 77, wherein the current-limiting unit is a resistor, a capacitor or an inductor.

79. The light emitting device according to claim 75, further comprising a rectifying unit electrically connected to the light emitting unit and the power supply unit.

80. The light emitting device according to claim 79, wherein the rectifying unit is a full-bridge rectifying circuit.

81. The light emitting device according to claim 45, wherein the optical sensing-control unit and the energy storage unit are connected in parallel.

82. The light emitting device according to claim 45, which is assembled as a package.

83. The light emitting device according to claim 45, wherein the first switching unit and the light emitting unit are connected in parallel.

84. The light emitting device according to claim 45, wherein the first switching unit and the light emitting unit are connected in series.

85. A method of controlling a light emitting device, which has at least a light emitting unit, at least a first switching unit, at least an energy storage unit and at least an optical sensing-control unit, the first switching unit being electrically connected to the light emitting unit, the energy storage unit being electrically connected to the first switching unit, the optical sensing-control unit being electrically connected to the energy storage unit, the method comprising the steps of:
storing an electrical energy in the energy storage unit;
turning on the first switching unit according to the electrical energy to enable the light emitting unit to emit light;
enabling the optical sensing-control unit to sense a light emitting energy of the light emitting unit and adjust the electrical energy stored in the energy storage unit; and
turning off the first switching unit according to the electrical energy to disable the light emitting unit from emitting the light.

86. The method according to claim 85, further comprising:
supplying a power to the light emitting unit.
